(19) United States
(12) Patent Application Publication
(10) Pub. No.: US 2026/0118482 A1
(43) Pub. Date: Apr. 30, 2026

(54) PEDESTRIAN PROTECTION SYSTEM FOR SENSOR CLEANING ASSEMBLY WITH ROTATING WINDOW

(71) Applicant: Zoox, Inc., Foster City, CA (US)

(72) Inventors: Bingchao Han, San Ramon, CA (US); Arvind Pattabhiraman, Alameda, CA (US); Raghuraman Surineedi, Menlo Park, CA (US); Austin In-Jei Yi, San Francisco, CA (US)

(73) Assignee: Zoox, Inc., Foster City, CA (US)

(21) Appl. No.: 18/933,735

(22) Filed: Oct. 31, 2024

(51) Int. Cl. G01S 7/481; G01S 7/497; G01S 13/931; G01S 17/86; H04N 23/51; H04N 23/90

(52) U.S. Cl. CPC G01S 7/4813; G01S 13/931; G01S 17/86; H04N 23/51; G01S 2007/4977; H04N 23/90

(57) ABSTRACT

A sensor assembly includes one or more sensors configured to collect data from an environment. A sensor window is disposed in a field of view of the sensor, such that the sensor senses the environment through the sensor window to generate sensor data. The sensor window is coupled to a sensor window housing that is rotated relative to the sensor. A deformable member is disposed proximate the sensor window housing to deform and absorb energy associated with an impact with the sensor window or the sensor window housing that causes movement of the sensor window housing relative to the sensor.

### BACKGROUND

Many vehicles in operation today are designed to perceive their surroundings using sensors. The sensors are often integrated into the vehicle, for example, in vehicle body panels. Integration into the vehicle body, however, often limits the field of view of the sensors. In other examples, at least in part to improve the field of view, sensors may be mounted to an exterior of a vehicle, such as on a roof of the vehicle. However, placement of the sensors on the exterior of the vehicle may increase a likelihood of the sensor impacting an external object, which may cause damage to the sensor and/or the impacted object. Accordingly, there is a need in the art for systems and techniques for reducing and/or mitigating damage occurring from impacts with sensor assemblies.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an illustration of an example vehicle having one or more sensor pods to collect and provide data to the autonomous vehicle, in accordance with examples of the disclosure.

FIG. 2 is a top perspective view of an example sensor pod including a sensor cleaning assembly, in accordance with examples of the disclosure.

FIG. 3 is an exploded perspective view of the sensor cleaning assembly of FIG. 2, in accordance with examples of the disclosure.

FIGS. 4A and 4B are cross-sectional views of the sensor cleaning assembly of FIG. 3, in a normal state in FIG. 4A and in a state resulting from an impact in FIG. 4B, in accordance with aspects of this disclosure.

FIG. 5 is an exploded perspective view of an example sensor cleaning assembly, in accordance with examples of the disclosure.

FIGS. 6A and 6B are cross-sectional views of an alternative arrangement of a sensor cleaning assembly, in accordance with examples of the disclosure.

FIGS. 7A and 7B are cross-sectional views of an alternative arrangement of a sensor cleaning assembly, in accordance with examples of the disclosure.

### DETAILED DESCRIPTION

As discussed above, integration of sensors into a body of a vehicle may not provide sufficient sensor coverage. Moreover, sensors that are integrated into a vehicle body may be less easily accessible, and thus more time consuming to install and/or replace. For example, removing a sensor for testing/replacement often requires the removal of the body panel and/or other portions of the vehicle. Aspects of the present disclosure relate to sensors mounted on an exterior of the vehicle. While such externally-mounted sensors are more readily installed, removed, replaced, and the like, the sensors may extend outboard of the vehicle body, effectively increasing a footprint of the vehicle.

Because of the positioning of the sensors away from the body of the vehicle, the sensor may be more prone to contact with objects proximate the vehicle, including pedestrians or sensitive portions of users. For example, a sensor pod may be located a distance from a ground and may present a hazard to a head of a pedestrian outside of the vehicle. To mitigate the effects of contacting a pedestrian, this application describes various impact structures that mitigate forces, and in particular forces resulting from collisions with the sensor pod when the vehicle is travelling in a forward direction.

Aspects of this disclosure relate specifically to mitigating forces associated with impacts with a sensor cleaning assembly. For example, some sensor assemblies can include sensor cleaning capabilities, and components associated with such cleaning can be harmful when contacted. For example, in some sensor cleaning assemblies, a sensor window may be disposed in front of a senor lens, thereby increasing a distance that a sensor would otherwise protrude. This extension may be more susceptible to being contacted. Moreover, although the sensor and/or housing for the sensor may be configured to mitigate damage from impacts therewith, the cleaning window and/or mounting structures for the cleaning window may be relatively rigid. Accordingly, aspects of this disclosure may provide impact mitigation for sensor cleaning assemblies.

In examples of this disclosure, a sensor cleaning assembly includes a sensor window disposed in a field of view of a sensor. Specifically, aspects of this disclosure relate to removing obstructions that can impact sensor data by positioning the sensor window such that would-be obstructions contact the sensor window (instead of the sensor). The sensor window may be a transparent disc placed in front of a lens of a sensor configured to image an environment. As detailed herein, the sensor window is configured to rotate or spin, e.g., such that obstructions on the sensor window disperse from the sensor window under a centrifugal force.

Aspects of this disclosure also include a sensor window housing for holding the sensor window. In examples, the sensor window housing may be configured to circumscribe or otherwise envelope a portion of a sensor. Accordingly, obstructions that may otherwise impact the sensor and that do not contact the sensor window may contact the sensor window housing. The sensor window may be fixed to the sensor window housing, such that rotation of the sensor window housing results in corresponding rotation of the sensor window.

In examples of this disclosure, a sensor window housing may be driven to rotate by an actuator. In some examples, the actuator may be a hollow core DC motor that includes a ring-shaped stator and a rotor configured to rotate within the stator. In examples, the rotor may be fixed to the sensor window housing.

In examples of this disclosure, a housing may be disposed as a shroud of covering at least partially surrounding the sensor window housing, the actuator, and/or the sensor. The housing may be configured such that the sensor window housing and the sensor window rotate relative to the housing. For example, a bearing may be disposed between an inner surface of the housing and an outer surface of the sensor window housing to facilitate such relative rotation.

The sensor window, the sensor window housing, the assembly housing, and/or the bearing may extend beyond a footprint of the sensor and thus may be susceptible to unintended impact, e.g., by pedestrians, objects, bicyclists, and/or the like. In some aspects of this disclosure, the sensor window housing is designed to move relative to the sensor during such an impact. For example, the bearing may be coupled to the housing and/or to the sensor window housing by a retention feature and/or a retention force that is overcome by a threshold force associated with an impact of a predetermined severity. For example, the sensor window housing may move axially relative to the sensor when subjected to this threshold force. In other examples, the housing may include one or more weakened regions that facilitate the described relative movement. In still further examples, a shear pin or similar feature may be provided to selectively prevent/cause movement of the sensor window housing relative to the housing.

Also, in examples of this disclosure, a deformation member may be provided to absorb energy associated with the movement of the sensor window housing. For example, a deformation member may be disposed in a path of travel of the sensor window housing to cushion or otherwise decrease an acceleration associated with the impact. In examples, the deformation member may plastically deform to gradually reduce the force associated with the impact.

Some examples of this disclosure are provided in the context of a vehicle having sensor pods disposed on the vehicle and including sensors to generate sensor data about an environment. In other examples, the sensor cleaning apparatus and methods described herein can be incorporated with individual, e.g., single, stand-alone sensors and/or other numbers and configurations of sensors. Moreover, although examples of this disclosure relate to sensors incorporated into sensor systems disposed on autonomous vehicles, aspects of this disclosure may be incorporated into sensor systems used in other vehicle types, including but not limited to semi-autonomous or manual vehicles including sensors for driver assistance and/or other functionalities. The sensor cleaning systems and methods described herein may also or alternatively be used with any other sensors used to surveille an environment for any purpose, e.g., whether or not associated with operation of a vehicle.

Additional details of this disclosure now will be described with reference to the Figures, in which the same reference numerals are used to reference the same components.

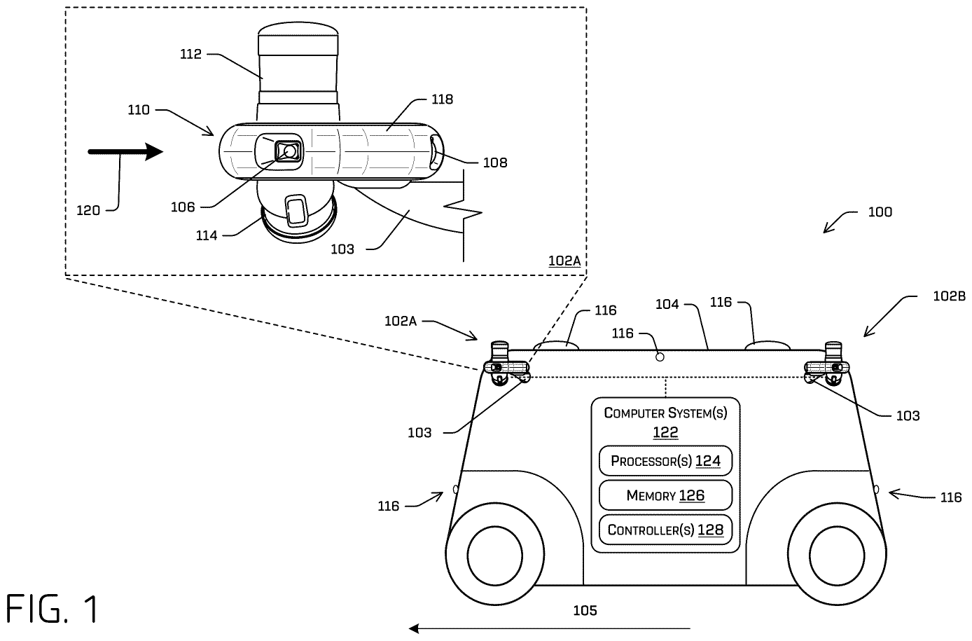

FIG. 1 is an illustration of an example vehicle 100 having one or more sensor pod assemblies configured with multiple sensors to collect information about the surroundings of the autonomous vehicle, in accordance with examples of the disclosure. The vehicle 100 shown in FIG. 1 is a bi-directional autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle may be a fully or partially autonomous vehicle having any other level or classification. Moreover, in some instances, aspects of sensor assemblies described herein may be applicable to non-autonomous and/or non-bidirectional vehicles as well. Also, while examples are given in which the vehicle is a land vehicle, the techniques described herein are also applicable to aerial, marine, and/or other vehicles.

In the illustrated example, the vehicle 100 includes a first sensor pod assembly 102A and a second sensor pod assembly 102B (collectively “the sensor pod assemblies 102”) coupled, via a sensor pod mount 103 to a body 104 of the vehicle 100. In FIG. 1, the first sensor pod assembly 102A is on a leading end of the vehicle 100 and the second sensor pod assembly 102B is on a trailing end of the vehicle 100 when the vehicle 100 is travelling forward in a direction shown by an arrow 105. As noted above, the vehicle 100 may be a bi-directional vehicle, e.g., configured to travel forward in the direction shown by the arrow 105 or alternately forward in an opposite direction. Thus, the sensor pod assemblies 102 may be alternately on the leading end of the vehicle, e.g., sensing objects generally in front of the vehicle 100, or on the trailing end of the vehicle 100, e.g., sensing objects generally behind the vehicle 100. In examples, each of the sensor pod assemblies 102 may be substantially identical, e.g., including the same or similar sensors configured to sense a field of view relative to the respective sensor pod assemblies 102.

FIG. 1 also includes a close-up of the first sensor pod assembly 102A. The sensor pod assembly 102A includes a plurality of sensors, including sensors of multiple modalities. Specifically, the sensor pod assembly 102A includes a side-facing camera 106 and a rear-facing camera 108. Although not visible in FIG. 1, the sensor pod assembly 102A also includes a front-facing camera (the location of which is shown generally by the reference numeral 110). The sensor pod assembly 102A also includes a first LiDAR sensor 112 and a second LiDAR sensor 114. As shown, the first LiDAR sensor 112 is generally on top of the first sensor pod assembly 102A and the second LiDAR sensor 114 is generally on a bottom of the first sensor pod assembly 102A. Although the first sensor pod assembly 102A is illustrated as including three cameras and two LiDAR sensors, the first sensor pod assembly 102A may include more, fewer, and/or different types of sensors. Moreover, and as shown in FIG. 1, the vehicle 100 may have one or more additional sensors 116 disposed at other positions on the vehicle 100.

FIG. 1 also shows that the first sensor pod assembly 102A includes an outer shell 118 or trim. The outer shell 118 may be disposed to protect aspects of the cameras 106, 108, 110 and/or the LiDAR sensors 112, 114, e.g., from the environment. Without limitation, the outer shell 118 can form an enclosure for the various sensors and electronic components disposed within the sensor pod assemblies 102.

In operation, the sensors associated with the sensor pod assemblies 102 are configured to generate sensor data associated with an environment of the vehicle. For instance, the sensor pod assemblies 102 may, together, have an effective field of view that provides sensor data for substantially all of the area surrounding the vehicle 100, e.g., 360-degrees about the vehicle 100. Moreover, sensors associated with the sensor pod assemblies 102 may be configured to provide overlapping fields of view, e.g., such that at least two sensors are configured to generate data for regions about the vehicle 100.

Data from the sensors associated with the sensor pod assemblies 102 is transmitted, e.g., via a wired or wireless connection, to one or more computer systems 122 associated with the vehicle 100. In some examples, the computer system(s) 122 control operation of one or more systems of the vehicle 100. In the illustrated example, the computer system(s) 122 include one or more processors 124, memory 126 communicatively coupled to the processor(s) 124, and one or more controllers 128. In examples, the memory may store instructions to receive and process sensor data from one or more sensors and to plan a route for the vehicle 100 through an environment. For instance, the planned route may be implemented via the controller(s) 128 operating the vehicle 100 autonomously.

The processor(s) 124 of the vehicle 100 may be any suitable processor capable of executing instructions to process data and perform operations as described herein. By way of example and not limitation, the processor(s) 124 may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

The memory 126 is an example of non-transitory computer-readable media. The memory 126 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 126 may include at least a working memory and a storage memory. For example, the working memory may be a high-speed memory of limited capacity (e.g., cache memory) that is used for storing data to be operated on by the processor(s) 124. In some instances, memory 130 may include a storage memory that may be a lower-speed memory of relatively large capacity that is used for long-term storage of data. In some cases, the processor(s) 124 cannot operate directly on data that is stored in the storage memory, and data may need to be loaded into a working memory for performing operations based on the data, as discussed herein.

As illustrated in FIG. 1, and as noted above, the sensor pod assemblies 102 are disposed on the vehicle 100 at positions to provide adequate fields of view for detecting objects relative to the vehicle 100. In some instances, including the illustrated example, the sensor pod assemblies 102 protrude from a side or top of the body 104 of the vehicle 100, e.g., to effectively increase the footprint of the vehicle 100. Accordingly, the positions of the sensor pod assemblies 102 may avail the sensor pod assemblies 102 to being impacted by obstructions. For example, when the vehicle 100 is driving in precipitation or foggy conditions, moisture may accumulate on the sensors, e.g., as water droplets, ice, or the like. For example, water droplets can accumulate on a lens of one or more of the cameras 106, 108, 110. The sensors may also be susceptible to being impacted by other obstructions, including but not limited to dust, debris, mud, bugs, and/or the like. These and/or other obstructions can adversely affect sensor data generated by the sensors in the sensor pod assemblies 102. For example, when a water droplet forms on a lens of the camera 106, the water droplet can occlude a portion of a field of view of the camera 106. This occlusion may result in degraded image data, which may result in false negatives and/or false positives when using the image data to identify objects.

Approaches to mitigating these obstructions and/or occlusions may include providing a sensor cleaning assembly. An example of a sensor cleaning assembly may be a spinning sensor window. For example, the sensor cleaning assembly may include a sensor window disposed in a field of view of the sensor and a sensor window housing coupled to the sensor window. An actuator rotates or spins the sensor window housing and the sensor window, and this rotation causes debris, moisture, and/or the like on the window to disperse, e.g., via centrifugal forces. Examples of a spinning sensor window are shown and described in U.S. application Ser. No. 18/233,246, filed on Aug. 11, 2023, and titled “SENSOR CLEANING ASSEMBLY WITH ROTATING SENSOR WINDOW,” the entirety of which is hereby incorporated by reference. While effective to reduce sensor degradation, the sensor cleaning apparatus may increase the footprint of the sensor and/or may include a relatively hard obstruction that can be harmful if contacted.

Although the computer system(s) 122 are configured to prevent contact with objects by the vehicle 100, including by the sensor pod assemblies 102, because of the location of the sensor pod assemblies 102 on the vehicle 100, the sensor pod assemblies 102 may be particularly prone to contacting objects (or being contacted by objects), including pedestrians, bicyclists, and/or the like, in the environment of the vehicle 100. That is, the vehicle 100 may have complex systems that aid in preventing unintended contact with people within the environment. In situations where contact is not prevented, however, the present disclosure provides additional protection, e.g., to limit injury to pedestrians that may contact the sensor pod assemblies 102.

Aspects of this disclosure are particularly directed to mitigating the effects of forces generally in the direction shown by arrow 120, which is generally opposite the direction of travel of the vehicle 100 (shown by the arrow 105 in FIG. 1.) More specifically, this disclosure describes impact mitigation structures and techniques for reducing an impact generally parallel to the direction of the arrow 120 proximate the front-facing camera 110. Such impact may be associated with contact of the sensor pod assembly, including the sensor cleaning assembly, with a pedestrian, for example.

One current measure of pedestrian protection is the Head Injury Criteria (“HIC”) score. The HIC score is one metric of determining the level of pedestrian protection provided by a vehicle. The HIC score may be calculated using equation (1):

$$HIC = {[ \frac{1}{{t}_{2} - {t}_{1}} {\int }_{{t}_{1}}^{{t}_{2}} adt ]}^{2.5} ( {t}_{2} - {t}_{1} ) \qquad ( 1 )$$

Specifically, as will be appreciated from Equation (1), the HIC score is a measure of the acceleration concentration as a proxy for force/energy applied over a period of time between t₁ and t₂. Specifically, in Equation (1), a is a resultant head acceleration, t₂ and t₁ describe a time period during which the highest HIC score is calculated, e.g., during a collision event, and wherein t₂−t₁≤15 ms. Thus, Equation (1) may be used to determine candidate HIC scores for any number of intervals of the time period, with the highest of the candidate HIC scores being the HIC score. The system may use one or more of the techniques described in Regulation (EC) No 78/2009 Of The European Parliament And Of The Council of 14 Jan. 2009 on the type-approval of motor vehicles with regard to the protection of pedestrians and other vulnerable road users (discussing Head Performance Criterion (“HPC”)) and European New Car Assessment Programme Pedestrian Testing Protocol, Version 8.4, November 2017 (discussing HIC15 testing) the disclosures of which are incorporated herein by reference, to test and determine an HIC or HPC score. In examples of this disclosure, impact mitigation systems associated with the sensor pod assemblies 102 may be configured to provide a pedestrian protection system with a HIC score below 1000, or more preferably below a HIC score of 900 during nominal driving conditions.

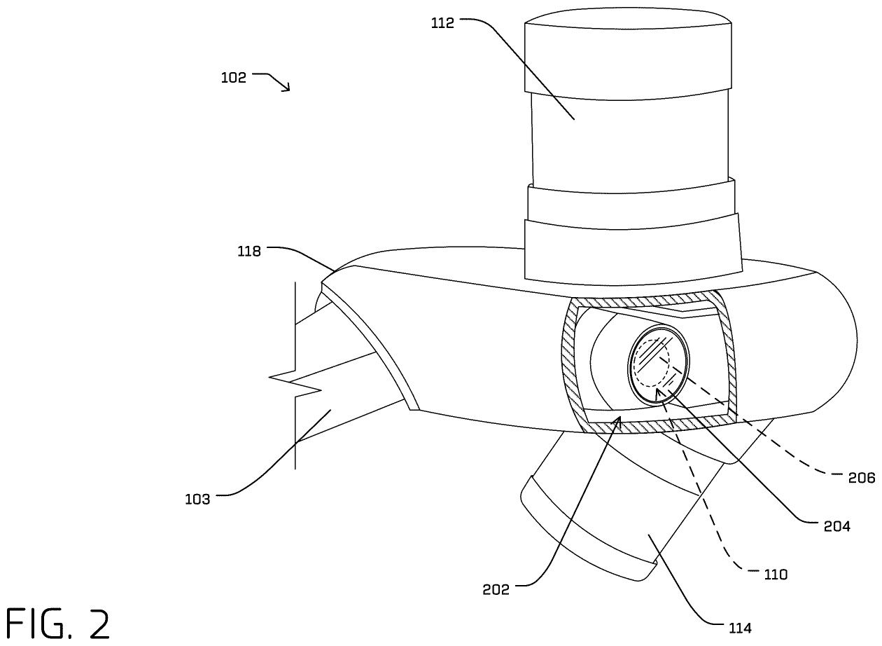

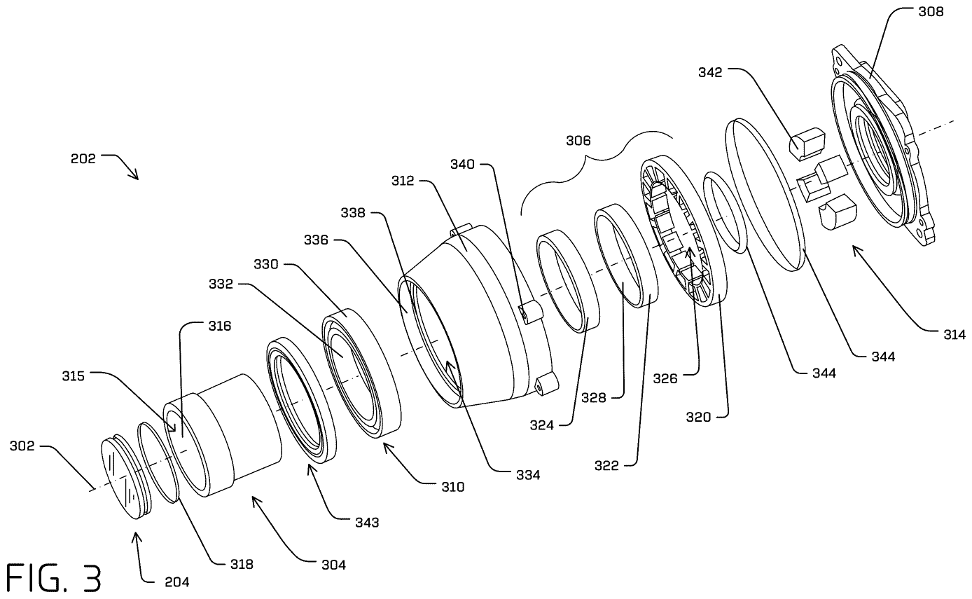

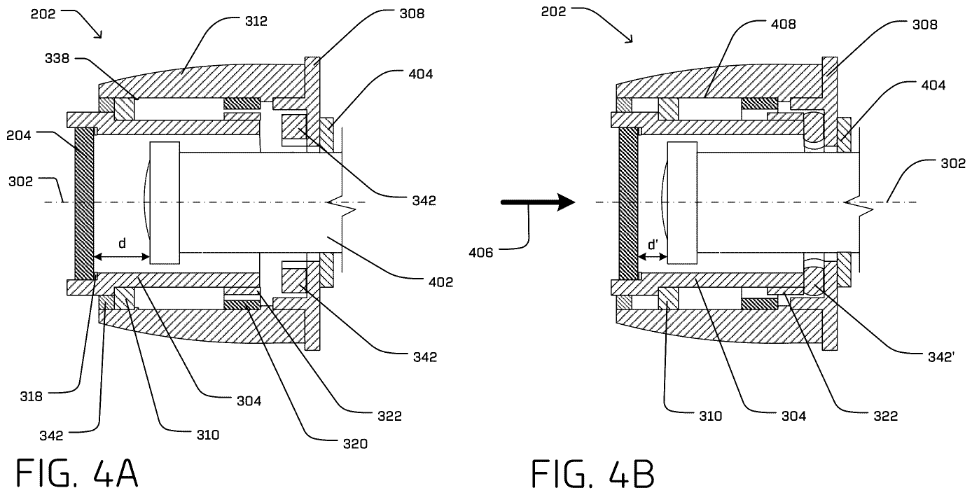

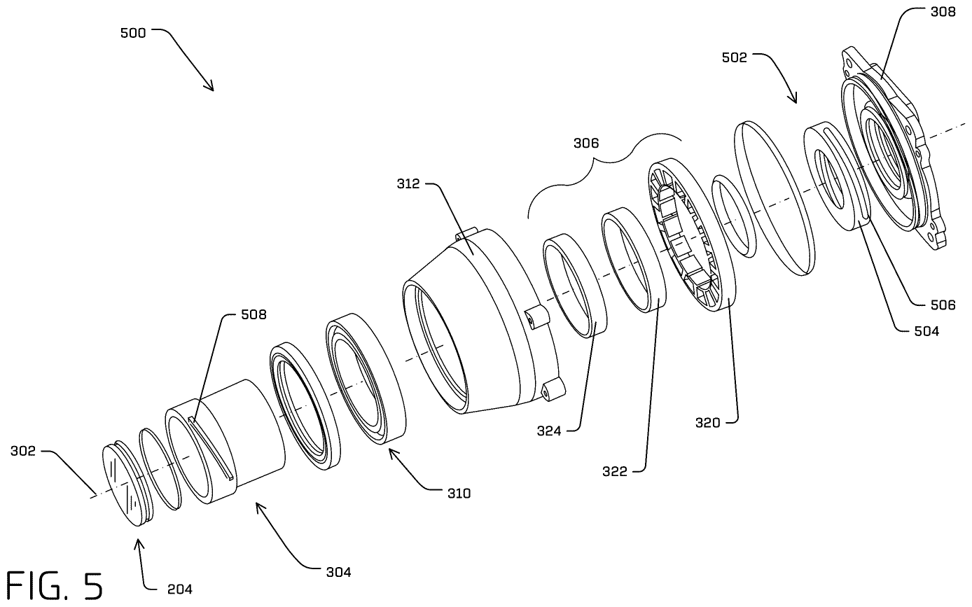

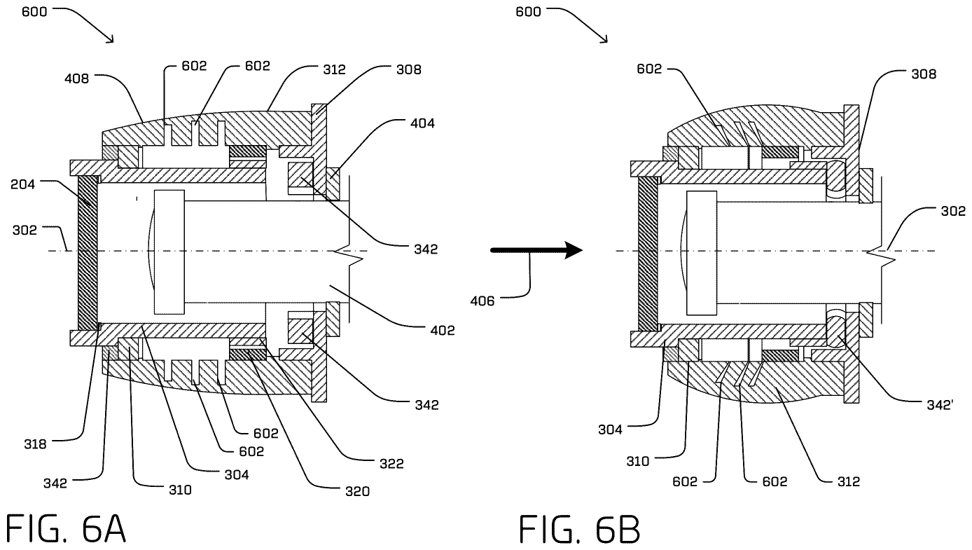

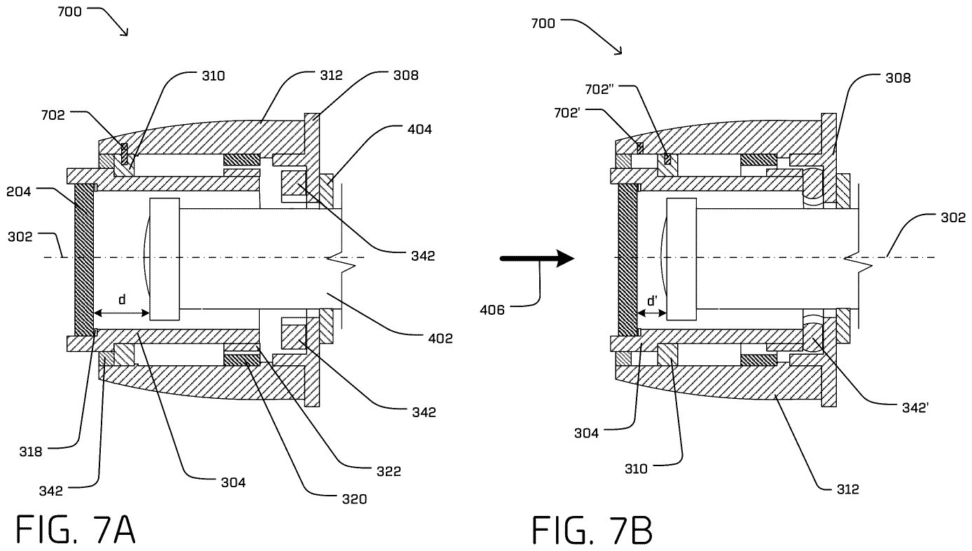

The impact mitigation structures of the present disclosure are detailed further below with reference to additional figures. Specifically, FIG. 2 is a perspective view of one of the sensor pod assemblies, with a portion of the outer shell 118 removed to illustrate aspects of a sensor cleaning system. FIG. 3 is an exploded perspective view of aspects of the sensor cleaning system of FIG. 2. FIGS. 4A and 4B are cross-sectional views showing aspects of the sensor cleaning assembly of FIG. 2 in a normal state and after an impact, respectively. FIG. 5 is an exploded perspective view of aspects of another example of the sensor cleaning system of FIG. 2. FIGS. 6A and 6B are cross-sectional views showing aspects of another example sensor cleaning assembly in a normal state and after an impact, respectively. FIGS. 7A and 7B are cross-sectional views showing aspects of another example sensor cleaning assembly in a normal state and after an impact, respectively.

FIG. 2 shows a perspective view of one of the sensor pod assemblies 102. For example, FIG. 2 is a top perspective view showing additional details associated with the outer shell 118 and some internal components. In the illustration, a portion of the outer shell 118 proximate the front-facing camera 110 is removed to show aspects of a sensor cleaning assembly 202. As detailed further herein, the sensor cleaning assembly 202 includes a sensor window 204, e.g., a transparent member, positioned relative to a sensor such that the sensor senses the environment through the sensor window 204. In the illustrated example of FIG. 2, the sensor cleaning assembly 202 includes the sensor window 204 in front of a lens 206 of the camera 110. Accordingly, image data generated by the camera 110 is based on light received through the sensor window 204. Stated differently, according to aspects of this disclosure, a sensor is positioned “behind” a transparent window, e.g., the sensor window 204, relative to the environment to be sensed. The sensor window 204 may comprise any material and/or medium through which an associated sensor may receive a signal indicative of the environment, and thus, may include, but is not limited to, transparent materials, translucent materials, glass, polymers, polycarbonates, and/or combinations thereof. As will be appreciated, although in the illustrated example the camera 110 is the sensor, in other examples the sensor cleaning assembly 202 may be associated with other types of sensors, including but not limited to time-of-flight sensors, imaging sensors, radar sensors, and/or the like.

In examples of this disclosure, a surface of the sensor window 204 opposite the sensor, e.g., opposite the camera 110, is exposed to the environment. Accordingly, any potential obstructions to generation of quality sensor data, e.g., rain, snow, debris, dust, bugs, or the like will impact the sensor window 204, e.g., instead of a lens of the sensor. Thus, aspects of this disclosure include functionality to clean the sensor window 204. Specifically, in aspects of this disclosure, the sensor window 204 is configured to rotate. In the illustrated example, the sensor window 204 is configured to rotate in a plane that is substantially (e.g., within a tolerance of) normal to the optical axis of the camera 110. Rotation of the sensor window 204 imparts a centrifugal force on any impediments or obstructions that may contact the sensor window 204. That is, as the sensor window 204 rotates, any objects e.g., water droplets, debris particles, or the like, that contact the sensor window 204 are, by action of the rotating window 204 dispersed in a direction away from the axis of rotation of the sensor window 204. By removing debris via this dispersion caused by rotation, the sensor window 204 may remain clean, allowing for a clear view of the environment for the sensor.

Some conventional sensor pod arrangements include features to mitigate damage associated with impacts with the sensor pod assembly 102. For example, U.S. Pat. No. 11,938,871, issued on Mar. 26, 2024, and titled “PEDESTRIAN PROTECTION SYSTEM FOR SENSOR POD CAMERA IMPACT” shows and describes systems and techniques for mitigating damage at sensor pods. The '871 patent is hereby incorporated by reference in its entirety. However, and as will be appreciated from FIG. 2, the sensor cleaning assembly 202, e.g., the sensor window 204 and/or a housing associated with the sensor cleaning assembly, extend beyond a footprint of the camera 110. Thus, impact with the sensor pod assembly 102 may result in an impact with the sensor cleaning assembly 202, e.g., before impact with the sensor. Thus, there is a need to mitigate damage associated with impacts with the sensor cleaning assembly 202.

FIG. 3 shows an example of aspects of the sensor cleaning system 202. Specifically, FIG. 3 is an exploded view of the sensor cleaning system 202, generally exploded along an axis 302. As will be described further herein, the axis 302 may also be an axis of rotation of the sensor window 204 and/or the axis 302 may be coincident with an optical or other sensing axis of the sensor with which the sensor cleaning system 202 is to be used.

In more detail, FIG. 3 shows the sensor window 204, a sensor window housing 304, an actuator 306, a sensor mount 308, a bearing 310, and a deformable member 312. Additional details of these features are detailed below with reference to FIG. 3.

As discussed above, the sensor window 204 may be a transparent member through which an environment is sensed/imaged. The sensor window 204 may be made of glass or other transparent material(s). In the illustrated example, the sensor window 204 is substantially circular, having a first face exposed to the environment and an opposite, second face facing a sensor (not shown in FIG. 3). The faces are separated by a window thickness. The faces of the sensor window 204 are illustrated as being substantially planar, although in other examples one or both of the faces may be contoured or otherwise modified. For example, one or both of the faces may be at least partially concave, at least partially convex, and/or otherwise shaped. Because the sensor window 204 is intended to be positioned between a sensor and the environment, e.g., such that the environment is sensed through the sensor window 204, in some instances it may be desirable to construct the sensor window 204 to reduce an impact to the sensor. For example, minimizing a thickness between the faces may achieve such an objective. In other examples, the sensor window 204 may be actively involved in the imaging. For example, the faces of the sensor window 204 can be configured to assist in influencing light entering the sensor, e.g., by refracting, steering, and/or otherwise. That is, in addition to providing cleaning benefits, the sensor window 204 may also be configured as an active lens element.

The sensor window housing 304 is configured to retain the sensor window 204. In the illustration, the sensor window housing 304 is substantially cylindrical, defining an opening 315. The opening 315 may be sized to circumscribe a portion of a sensor, such as a camera lens or the like. As shown in FIG. 3, proximate a first end of the opening 315, the sensor window housing 304 may be stepped, e.g., to include a ledge bounded circumferentially by a window positioning sidewall 316. When assembled, the second face of the sensor window 204 contacts the ledge, and the window positioning sidewall 316 constrains lateral movement of the sensor window 204. In examples, the circumference of the window positioning sidewall 316 may provide a slight clearance fit with an outer edge of the sensor window 204.

As also illustrated in FIG. 3, a gasket or seal 318 may be provided. The seal 318 may seal the sensor window 204 relative to the sensor window housing 304, e.g., to prevent debris, moisture, or the like from entering the sensor window housing 304 at an interface of the sensor window 204 and the sensor window housing 304. In the illustrated example, the seal 318 may be received in a circumferential slot formed about the sensor window 204. Once received in the slot, the seal 318 contacts the window positioning sidewall 316. In other examples, the seal 318 may be otherwise disposed. Without limitation, the seal 318 may be disposed between the second face of the sensor window 204 and the ledge.

When assembled, the sensor window 204 may be fixed to the sensor window housing 304. For example, an epoxy, adhesive, or other chemical agent may be used to secure the sensor window 204 to the ledge. In other examples, the circumference of the window positioning sidewall may form an interference fit with the sensor window 204, e.g., such that the sensor window 204 is press fit into the sensor window housing 304. In still further examples, the sensor window housing 304 may include one or more tabs, detents, or other retention mechanisms that may mechanically secure the sensor window 204 to the sensor window housing 304. Regardless of the manner in which the sensor window 204 is secured to the sensor window housing 304, in examples of this disclosure, the coupling of the sensor window 204 to the sensor window housing facilitates corresponding rotation of the sensor window 204 when the sensor window housing 304 is rotated, e.g., about the axis 302.

The actuator 306 is configured to facilitate rotation of the sensor window housing 304. In the illustrated example, the actuator 306 is a brushless DC motor, such as a hollow core or shaftless motor. More specifically, the actuator 306 includes a stator 320, a rotor 322, and a retention member 324. In more detail, the stator 320 includes a number of windings spaced about a central opening 326. Although not shown in FIG. 3, the actuator 306 may include electrical connections, e.g., which may be selectively controlled to provide current to the windings. For example, the windings may be selectively controlled to cause the rotor 322 to spin or rotate in the opening 326 of the stator 320. In examples, the rotor 322 includes one or more magnets and has an outer diameter that provides a clearance fit with the opening 326 of the stator 320.

The retention member 324 is provided to retain the rotor 322 on the sensor window housing 304. In the illustrated example, the rotor 322 is configured as a ring, defining an inner surface 328. The retention member 324 also is configured as a ring-shaped member. In this example, the retention member 324 is retained in the rotor 322, such that an outer surface of the retention member 324 is fixed to the inner surface 328 of the rotor 322. Without limitation, the retention member 324 may be press fit into the rotor 322, fastened to the rotor 322, e.g., using an adhesive, epoxy, and/or mechanical means, or otherwise coupled to the rotor 322. The retention member 324 is, in turn, coupled to the sensor window housing 304. For example, the retention member 324 may be press fit onto an outer surface of the sensor window housing 304 or otherwise fastened to the sensor window housing 304. In other examples, the retention member 324 may be integrated into the rotor 322 and/or the rotor 322 may be secured directly to the sensor window housing 304 (e.g., the retention member 324 may be omitted).

The bearing 310 facilitates rotation of the sensor window housing 304, e.g., relative to the housing 312. In the example illustrated in FIG. 3, the bearing 310 includes an outer ring 330 and an inner, concentric ring 332. The rings 330, 332 are configured to rotate relative to each other, e.g., about the axis 302. The bearing 310 may be a ring bearing, a ball bearing, or the like. When assembled, the inner ring 332 may be secured to the sensor window housing 304. For example, the inner ring 332 may be sized to be pressed onto an outer surface of the sensor window housing 304, e.g., to form an interference fit with the outer surface. In examples, when the bearing 310 is secured to the sensor window housing 304, the bearing 310 may abut a step or other feature on the sensor window housing 304, although such is not required.

The outer ring 330 of the bearing 310 is secured to the housing 312. In the illustrated example of FIG. 3, the housing 312 defines an inner opening 334. For example, the opening 334 may be sized to circumscribe a portion of a sensor with which the system 202 is to be used, the actuator 306, and/or the sensor window housing 304. The opening 334 may be contoured, and may include a bearing retention surface 336. In the example, the bearing retention surface 336 may a substantially cylindrical sidewall sized to receive the outer ring 330 of the bearing 310. For example, the bearing retention surface 336 may have a diameter that is sized to provide an interference or press fit with the outer surface of the outer ring 330. Also illustrated in FIG. 3, the opening 334 can define a bearing retention ledge 338, e.g., normal to an axial extent of the bearing retention surface 336. When the bearing 310 is received in the bearing retention surface 336, the bearing retention ledge 338 may position the bearing axially, e.g., by acting as a stop against which the bearing 310 abuts upon insertion into the opening 334.

The housing 312 can include additional or other features, as well. For instance, the housing 312 may also include one or more features for securing the sensor housing 312 to the sensor mount 308. For example, the housing 312 can include a plurality of apertures 340 through which fasteners may be inserted and coupled to the sensor mount 308.

As will be appreciated, the housing 312 may function as a shroud or covering that prevents debris, moisture, and/or the like from affecting the sensor. In the example of FIG. 3, a gasket 343 also is illustrated, which may be disposed to seal the sensor window housing 304 relative to the housing 312, e.g., proximate the bearing. Additional seals 344 also are illustrated. In example, the additional seals may be provided to seal the housing 312 relative to the sensor mount 308, to seal the sensor mount 308 relative to a sensor (not shown in FIG. 3) and/or to otherwise provide additional seals. The additional seals 344 may be provided to create a sealed environment within a volume defined at least in part by the sensor window 204, the sensor window housing 304, the housing 312, and the sensor mount 308.

In examples, the sensor mount 308 may include one or more holes, threads, and/or other features to secure the sensor mount 308 in a position such that the sensor cleaning assembly 202 is fixed relative to a sensor (not shown in FIG. 3). As also shown in FIG. 3, the sensor mount can also include one or more protrusions extending generally along the axis 302 from a face of the sensor mount 308. The protrusions are illustrated as extending proximate an outer edge of the opening. In some instances, the protrusions may function as positioning or alignment features. In one non-limiting example, a rear surface of the sensor mount 308 (e.g., the surface normal to the axis 302 that is obscured in FIG. 3) may provide a first datum surface to which a surface of a sensor, like the camera 110, is mounted. Surfaces of the protrusions may provide a spacing from the datum surface to properly position components relative to the sensor.

The deformation member 314 is provided to mitigate damage associated with an impact with the sensor cleaning assembly 202. In the illustrated example, the deformation member 314 is illustrated as a plurality of shims 342. In this example, the shims 342 are spaced circumferentially, e.g., equidistantly, about the axis 302. Although four instances of the shims 342 are illustrated, in other examples more or fewer of the shims 342 may be used.

The shims 342 may be coupled to the sensor mount 308. As shown the shims 342 extend in a direction parallel to the axis 302 from the sensor mount 308. As detailed further herein, when an impact with the sensor cleaning assembly 202 occurs, e.g., an impact with the sensor window 204 or the sensor window housing 304, one or more of the components of the sensor cleaning assembly 202 moves, generally along the axis 302. The shims 342 are positioned to be contacted by this moving component(s), and to absorb forces generated by the impact. For example, the shape, properties, and/or other aspects of the deformation member 314 may cause a local plastic deformation, thereby absorbing energy from an impact and away from the pedestrian or other object contacting the sensor cleaning assembly 202. For example, the absorption of this energy may reduce an acceleration concentration experienced by a pedestrian. For example, the deformation member 314 may be made from rubber, plastics (e.g., Polyethylene Terephthalate (PET or PETE or Polyester), High-Density Polyethylene (HDPE), Polyvinyl Chloride (PVC), Low-Density Polyethylene (LDPE), Polypropylene (PP), Polystyrene (PS), (ABS), others), polycarbonates, polyamide, and/or combinations thereof. For example, and without limitation, the number and/or composition of the shims may be selected, configured, and/or arranged to control the HIC score and/or other aspects of collision mitigation, e.g., by altering the energy absorption characteristics.

FIGS. 4A and 4B are cross-sectional views of aspects of the sensor cleaning assembly 202 in an assembled state. In FIGS. 4A and 4B, the same reference numerals used in FIGS. 1-3 are used to identify the same components. As illustrated, the sensor cleaning assembly 202 provides a compact arrangement that facilitates rotation of the sensor window 204. Specifically, when the stator 320 is selectively energized, the rotor 322 rotates. The rotation of the rotor 322 causes a corresponding rotation of the sensor window housing 304 about the axis 302. The bearing 310 facilitates this rotation of the sensor window housing 304, e.g., relative to the housing 312 and the sensor mount 308.

As also shown in FIG. 4A, a sensor 402 is mounted to the sensor mount 308, e.g., via a sensor mounting feature 404. The sensor 402 may include one or more image capture devices, LIDAR sensors, and/or TOF sensors (e.g., such as one or more of the sensors 106, 108, 110, 112, 114, 116, described herein), though any other sensor is contemplated. The sensor window housing 304 is also configured to rotate relative to the sensor 402. As also shown in FIG. 4A, the sensor 402 extends into a space defined at least in part by the housing 312, the sensor window housing 304, and/or the sensor window 204. As shown, the sensor window housing 304 provides a radial clearance relative to the sensor, and an axial end of the sensor 402, e.g., a lens of the sensor 402, is spaced from the sensor window 204 by a distance, d.

During rotation of the sensor window 204, water droplets, dirt, debris, and/or the like contacting the sensor window 204 will experience a centrifugal force, e.g., radially away from the axis of rotation 302 of the sensor window 204. Under this centrifugal force the would-be obstructions to the sensor will disperse from the sensor window 204. In examples, the sensor window 204 may be rotated at speeds of from about 4000 RPM to about 6000 RPM. Moreover, the actuator 306 may be configured to drive the sensor window 204 in either a clockwise or a counterclockwise direction.

FIG. 4B shows a configuration in which the sensor cleaning assembly 202 has been impacted. In that Figure, the impact is generally illustrated by the arrow 406. The impact may be at the sensor window 204 and/or at the sensor window housing 304, for example. As illustrated, a force associated with the impact is sufficient cause a deformation of the sensor cleaning assembly 202. More specifically, and as illustrated, as a result of the impact, the sensor window 204, the sensor window housing 304, the bearing 310 and the rotor 322 are all driven, generally along the axis 302, toward the sensor mount 308. As these components are driven in this manner, an end of the sensor window housing 304, e.g., an end opposite the end retaining the sensor window 204, contacts the shims 342, e.g., as the deformation member 314. As shown at reference numeral 342′, the shims plastically deform, e.g., compress, to decelerate the movement of the sensor window housing 304 and associated components. The deformation member 314 effectively absorbs forces associated with the impact.

The deformation member 314 may also act to protect the sensor 402 and/or other components of the sensor cleaning assembly 202. As illustrated by FIG. 4B, the distance, d, has been reduced to a distance, d′, but the sensor window 204 is still spaced form the sensor 402. Because the sensor window 204 does not contact the sensor 402, the sensor 402 may not be damaged by the impact.

In the illustrated example, the sensor window housing 304 moves relative to the housing 312 because of a configuration of the interface of the bearing 310 with the housing 312. More specifically, in the example, the bearing retention ledge 338 is configured to fail, e.g., fracture or the like, at a predetermined force. Thus, when the impact force meets or exceeds the predetermine force, the bearing retention ledge 338 will fracture, allowing the bearing 310 and the sensor window housing 304 to move as shown in FIG. 4B. In other examples, the bearing retention ledge 338 may not be included. For instance, the bearing 310 may be press fit or otherwise retained only against an inner surface 408 of the housing 312. In this example, a sufficient force along the arrow 406 will overcome the retention force holding the bearing 310 in place. That is, the interface of the bearing 310 and the inner surface 408 of the housing 312 may be designed to provide a retention force that can be overcome by a predetermined axial force.

In the illustrated example, the sensor cleaning assembly 202 is configured to “fail” at the interface of the bearing 310 and the housing 312, such that the sensor window housing 304 moves toward and contacts the shims 342 as the deformation member 314. However, any arrangements that allow for movement of the sensor window housing 304 may be used. For example, the interface between the bearing 310 and the sensor window housing 304 may be designed such that sensor window housing 304 moves relative to the bearing 310 under a predetermined axial force. Without limitation, although the sensor window housing 304 is illustrated as including a stepped outer surface providing a ledge against which the bearing 310 abuts, in other examples, the outer surface of the sensor window housing 304 may be substantially cylindrical, such that bearing 310 is press fit onto the sensor window housing 304. A retention force associated with this press fit may be configured to be overcome during an impact having an associated threshold impact force. Thus, in this alternative example, the sensor window housing 304, the sensor window 204 and the rotor 322 would move relative to the bearing 310 (as well as the housing 312 and the like).

Other modifications to the example of FIGS. 3, 4A, and 4B also are contemplated. For example, FIG. 5 is an exploded perspective view of an alternative arrangement of a sensor cleaning assembly 500. The sensor cleaning assembly 500 includes many of the same components as the sensor cleaning assembly 202, and the same reference numerals are used in FIG. 5 to show the same features discussed above.

The sensor cleaning assembly 500 generally includes the sensor window 204, the sensor window housing 304, the actuator 306, the sensor mount 308, the bearing 310, and the housing 312. The sensor cleaning assembly 500 also includes a deformation member 502, which is different from the deformation member 314 discussed above. The deformation member 502 is formed as a ring-shaped member having a body 504. The deformation member 502 may be secured to the sensor mount 308 and/or may perform substantially the same function as the deformation member 314. Specifically, the deformation member 502 may be configured to absorb energy upon being contacted by the sensor window housing 304, e.g., during an impact event. In some examples, the deformation member 502 may be made of a material that plastically deforms to absorb the forces associated with the impact. Without limitation, the deformation member 502 can be made from one or more of rubber, plastics (e.g., Polyethylene Terephthalate (PET or PETE or Polyester), High-Density Polyethylene (HDPE), Polyvinyl Chloride (PVC), Low-Density Polyethylene (LDPE), Polypropylene (PP), Polystyrene (PS), (ABS), others), polycarbonates, polyamide, and/or combinations thereof.

As also illustrated in FIG. 5, the deformation member 502 may optionally include one or more cutouts 506. For example, the cutouts 506 may be formed as cutouts or the like that serve to weaken the body 504 of the deformation member 502. Two cutouts 506 are shown in FIG. 5, but more or fewer cutouts 506 may be used. Generally, any indentations, holes, slits, slots, and/or the like may be formed in the body 504 of the deformation member 502. The cutouts 506 may be used to control aspects of compression of the deformation member 502 during an impact event. Without limitation, more and/or larger cutouts 506 may allow the deformation member to compress further and/or more quickly during an impact whereas fewer and/or smaller cutouts 506 may cause the deformation member 502 be relatively stiffer. Thus, and as will be appreciated, varying the number and/or arrangement of the cutouts 506 may tune or otherwise adjust aspects of the compression of the deformation number, which may control energy absorption, the HIC score and/or other attributes of a collision.

FIG. 5 also shows features for facilitating passive rotation of the sensor window housing 304, and thus of the sensor window 204. More specifically, FIG. 5 shows that the sensor window housing 304 includes one or more fins 508 (one is visible in FIG. 5) disposed on an outer circumference of the sensor window housing 304. The fin(s) 508 are formed on the outer surface of the relatively larger diameter portion of the sensor window housing 304. Thus, when the sensor cleaning assembly 500 is assembled, the fin(s) 508 are disposed outside the housing 312. Accordingly, in operation, the fin(s) 508 are exposed to the ambient environment and are configured such that, as the vehicle travels through an environment, air passing over the fin(s) 508 causes the sensor window housing 304 (and thus the sensor window 204) to rotate as detailed above. For example, the fin(s) 508 may be helical or otherwise angled radially extending protrusions disposed such that air contacting the fin(s) 508, e.g., air moving relative to the sensor window housing 304 generally along the direction of the axis 302, imparts a rotational motion of the housing 304, about the axis 302. Thus, the fin(s) 508 may facilitate rotation of the sensor window 204 without active driving by the actuator 306, particularly when the vehicle on which the sensor assembly is mounted is moving.

Although included in the example of FIG. 5, the fin(s) 508 may be provided on other assemblies described herein. Moreover, the fin(s) 508 may be optional, e.g., such that the assembly 500 may include other of the features illustrated in FIG. 5, but may omit the fin(s) 508.

FIGS. 6A and 6B show yet another alternative arrangement for a sensor cleaning assembly 600 with impact mitigation. In FIGS. 6A and 6B, the same reference numerals previously introduced herein are used to show the same features. As illustrated, like the sensor cleaning assembly 202 and the sensor cleaning assembly 500, the sensor cleaning assembly 600 includes the sensor window 204, the sensor window housing 304, the stator 320, the rotor 322, the sensor mount 308, the bearing 310, and the housing 312.

Unlike in previous examples, the sensor cleaning assembly 600 is configured to otherwise deform during an impact along the arrow 406. More specifically, the housing 312 in the example of FIGS. 6A and 6B includes a plurality of weakened portions 602. In the illustrated example, the weakened portions 602 are formed as grooves or channels in the inner surface 408 of the housing 312. As illustrated in FIG. 6B, during an impact, the weakened portions 602 facilitate a (controlled) deformation of the housing 312, which effectively causes the housing 312 to compress along the axis 302. In this example, the bearing interfaces at each of the housing 312 and the sensor window housing 304 may remain intact, but the sensor window housing 304 still moves relative to the sensor 402. And this movement is similarly arrested by the deformation member. The deformation member is illustrated in FIGS. 6A and 6B by the shims 342, although any other deformation members, including the deformation member 502 and/or any modifications discussed herein, may be used with the example of FIGS. 6A and 6B.

Although the weakened portions 602 are illustrated as grooves or channels in FIGS. 6A and 6B, in other examples the weakened portions 602 may be otherwise formed. For example and without limitation, the weakened portions 602 may be formed as a number of holes or slots formed through the housing 312, a reduced thickness area of the housing 312, one or more frangible sections, or the like. The weakened portions 602 may be any features or configurations that allow for deformation of the housing to facilitate axial movement of the sensor window housing 304 relative to the sensor 402. Moreover, although multiple instances of the weakened portions 602 are illustrated, in other examples the weakened portions 602 may comprise more or fewer (e.g., a single) feature that promote or facilitate deformation of the housing 312.

FIGS. 7A and 7B show yet another alternative arrangement for a sensor cleaning assembly 700 with impact mitigation. In FIGS. 7A and 7B, the same reference numerals previously introduced herein are used to show the same features. As illustrated, like the sensor cleaning assembly 202, the sensor cleaning assembly 500, and the sensor cleaning assembly 600, the sensor cleaning assembly 700 includes the sensor window 204, the sensor window housing 304, the stator 320, the rotor 322, the sensor mount 308, the bearing 310, and the housing 312.

Unlike in previous examples, the sensor cleaning assembly 700 is configured to otherwise deform during an impact along the arrow 406. More specifically, the sensor cleaning assembly 700 includes a shear pin 702 coupling the housing 312 and the bearing 310. In the example of FIG. 7A, the shear pin extends at least partially into the housing 312 and at least partially into the bearing 310. As will be appreciated, in this example, the shear pin 702 may extend only into an outer ring, e.g., the outer ring 330 discussed above, of the bearing 310, so as to not impede rotation of the sensor window housing 304.

During an impact event, as shown in FIG. 7B, the shear pin 702 shears, such that a first portion 702′ remains in the housing 312 and a second portion 702″ remains in the bearing 310. Once sheared in this manner, the sensor window housing 304 moves (axially) relative to the housing 312, generally as in other examples described herein. A deformation member similarly arrests this movement. The deformation member is illustrated in FIG. 7 by the shims 342, although any other deformation members, including the deformation member 502 and/or any modifications discussed herein, may be used with the example of FIGS. 7A and 7B.

Although FIGS. 7A and 7B show only a single instance of the shear pin 702, multiple shear pins can be provided. In one non-limiting example, multiple instances of the shear pin 702 may be spaced about a circumference of the bearing 310. Moreover, although the shear pin 702 is illustrated as coupling the bearing 310 and the housing 312, in another example the shear pin 702 may be disposed to couple the bearing 310 and the sensor window housing 304. In such an example, the sensor window housing may have a generally cylindrical outer surface, e.g., not including the stepped outer profile, such that the sensor window housing 304 can move relative to the bearing 310 when the shear pin 702 is sheared.

Although aspects of this disclosure are detailed above with reference to example sensor cleaning assemblies, modifications to the sensor cleaning assemblies also are contemplated. For example, and without limitation, the spinning sensor windows described may be differently driven than by the actuator 306. For example, U.S. patent application Ser. No. 18/223,246, discussed above, has an off-axis motor that uses a belt to drive a rotating window. The energy absorbing techniques described herein may be integrated into such systems.

### Example Clauses

Any of the example clauses in this section may be used with any other of the example clauses and/or any of the other examples or embodiments described herein.

A: A sensor system for a vehicle, the sensor system comprising: a sensor configured to generate sensor data indicative of an environment of the vehicle; a frame coupling the sensor to the vehicle; a sensor window proximate the sensor and disposed such that the sensor senses the environment through the sensor window to generate the sensor data; a sensor window housing coupled to the sensor window; an actuator configured to cause the sensor window housing and the sensor window to rotate relative to the sensor, about an axis of rotation that is substantially coaxial with an axis of the sensor; and a deformable member disposed between the sensor window housing and the frame, the deformable member configured to deform and absorb energy associated with an impact with the sensor window or the sensor window housing that causes movement of the sensor window housing relative to the frame.

B: The sensor system of paragraph A, wherein: the sensor window housing comprises a cylindrical outer surface extending between a first end coupled to the sensor window and a second end; and the deformable member is positioned proximate the second end of the sensor window housing.

C: The sensor system of paragraph A or paragraph B, wherein: the deformable member comprises a plurality of shims extending along a length generally parallel to the axis of rotation; and the plurality of shims are configured to plastically deform in response to the impact.

D: The sensor system of any one of paragraphs A through C, wherein: the deformable member comprises a sidewall defining a sensor opening at least partially surrounding the sensor; and the sidewall has a weakened area configured to deform.

E: The sensor system of any one of paragraphs A through D, further comprising: a bearing having a first surface coupled to the sensor window housing and a second surface coupled to the frame to facilitate rotation of the sensor window housing relative to the frame, wherein a force associated with the impact overcomes a retention force at the first surface or the second surface and causes the movement of the sensor window housing relative to the frame.

F: The sensor system of any one of paragraphs A through E, wherein: the actuator comprises a rotor and a stator; the rotor is disposed within a volume defined by the stator; and the rotor is coupled to the sensor window housing.

G: A sensor system comprising: a sensor configured to generate sensor data corresponding to a field of view of the sensor; a sensor window disposed proximate the sensor such that the sensor senses an environment through the sensor window to generate the sensor data; a sensor window housing to which the sensor window is coupled; an actuator configured to rotate the sensor window housing and the sensor window relative to the sensor about a rotational axis that extends into the field of view of the sensor; and a deformable member configured to deform and absorb energy associated with an impact with the sensor window or the sensor window housing that causes movement of the sensor window housing relative to the sensor.

H: The sensor system of paragraph G, wherein: the deformable member is configured to plastically deform in response to the impact.

I: The sensor system of any one of paragraphs G through H, wherein: the deformable member comprises a plurality of shims; and individual of the plurality of shims includes a deformable body having a first end disposed proximate the sensor window housing and a second end spaced from the first end along a direction generally parallel to a rotational axis of the sensor window housing.

J: The sensor system of any one of paragraphs G through I, further comprising: a housing disposed at least partially over the sensor window housing; and a bearing disposed between the housing and the sensor window housing that facilitates rotation of the sensor window housing relative to the housing.

K: The sensor system of any one of paragraphs G through J, wherein, as a result of the impact, the sensor window housing moves relative to the bearing.

L: The sensor system of any one of paragraphs G through K, wherein: the bearing comprises a bearing surface; the bearing surface is retained in contact with a surface of the sensor window housing by a retention force; and the retention force is overcome by an impact force associated with the impact to cause the sensor window housing to move relative to the bearing.

M: The sensor system of any one of paragraphs G through L, further comprising a shear pin coupling the sensor window housing to the bearing, wherein, as a result of the impact, the shear pin fails, facilitating movement of the sensor window housing relative to the bearing.

N: The sensor system of any one of paragraphs G through M, wherein, as a result of the impact, the sensor window housing and the bearing move relative to the housing.

O: The sensor system of any one of paragraphs G through N, wherein: the housing comprises a weakened portion at which the housing deforms as a result of the impact.

P: A sensor cleaning system for mitigating obstructions to generating sensor data, the sensor cleaning system comprising: a sensor window housing configured to be mounted relative to a sensor; a sensor window coupled to the sensor window housing, the sensor window being disposed proximate the sensor such that the sensor senses an environment through the sensor window to generate the sensor data; an actuator configured to rotate the sensor window relative to the sensor about a rotational axis that extends into a field of view of the sensor; and a deformable member configured to absorb energy associated with an impact with the sensor window housing or the sensor window that causes movement of the sensor window housing relative to the sensor.

Q: The sensor cleaning system of paragraph P, wherein: the sensor window housing comprises a cylindrical outer surface extending between a first end coupled to the sensor window and a second end; and the deformable member is positioned proximate the second end of the sensor window housing.

R: The sensor cleaning system of paragraph P or paragraph Q, wherein the deformable member comprises a plurality of shims extending along a length generally parallel to the rotational axis.

S: The sensor cleaning system of any one of paragraphs P through R, further comprising: a housing; and a bearing having a first surface coupled to the sensor window housing and a second surface coupled to the housing to facilitate rotation of the sensor window housing relative to the housing, wherein a force associated with the impact overcomes a retention force at the first surface or the second surface and causes the movement of the sensor window housing relative to the sensor frame.

T: The sensor cleaning system of any one of paragraphs P through S, further comprising a shear pin providing the retention force.

While the example clauses described above are described with respect to one particular implementation, it should be understood that, in the context of this document, the content of the example clauses may also be implemented via a method, device, system, a computer-readable medium, and/or another implementation.

### CONCLUSION

While one or more examples of the techniques described herein have been described, various alterations, additions, permutations, and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A sensor system for a vehicle, the sensor system comprising:
a sensor configured to generate sensor data indicative of an environment of the vehicle;
a frame coupling the sensor to the vehicle;
a sensor window proximate the sensor and disposed such that the sensor senses the environment through the sensor window to generate the sensor data;
a sensor window housing coupled to the sensor window;
an actuator configured to cause the sensor window housing and the sensor window to rotate relative to the sensor, about an axis of rotation that is substantially coaxial with an axis of the sensor; and
a deformable member disposed between the sensor window housing and the frame, the deformable member configured to deform and absorb energy associated with an impact with the sensor window or the sensor window housing that causes movement of the sensor window housing relative to the frame.

2. The sensor system of claim 1, wherein:
the sensor window housing comprises a cylindrical outer surface extending between a first end coupled to the sensor window and a second end; and
the deformable member is positioned proximate the second end of the sensor window housing.

3. The sensor system of claim 1, wherein:
the deformable member comprises a plurality of shims extending along a length generally parallel to the axis of rotation; and
the plurality of shims are configured to plastically deform in response to the impact.

4. The sensor system of claim 1, wherein:
the deformable member comprises a sidewall defining a sensor opening at least partially surrounding the sensor; and
the sidewall has a weakened area configured to deform.

5. The sensor system of claim 1, further comprising:
a bearing having a first surface coupled to the sensor window housing and a second surface coupled to the frame to facilitate rotation of the sensor window housing relative to the frame,
wherein a force associated with the impact overcomes a retention force at the first surface or the second surface and causes the movement of the sensor window housing relative to the frame.

6. The sensor system of claim 1, wherein:
the actuator comprises a rotor and a stator;
the rotor is disposed within a volume defined by the stator; and
the rotor is coupled to the sensor window housing.

7. A sensor system comprising:
a sensor configured to generate sensor data corresponding to a field of view of the sensor;
a sensor window disposed proximate the sensor such that the sensor senses an environment through the sensor window to generate the sensor data;
a sensor window housing to which the sensor window is coupled;
an actuator configured to rotate the sensor window housing and the sensor window relative to the sensor about a rotational axis that extends into the field of view of the sensor; and
a deformable member configured to deform and absorb energy associated with an impact with the sensor window or the sensor window housing that causes movement of the sensor window housing relative to the sensor.

8. The sensor system of claim 7, wherein:
the deformable member comprises a plurality of shims; and
individual of the plurality of shims includes a deformable body having a first end disposed proximate the sensor window housing and a second end spaced from the first end along a direction generally parallel to a rotational axis of the sensor window housing.

9. The sensor system of claim 7, further comprising:
a housing disposed at least partially over the sensor window housing; and
a bearing disposed between the housing and the sensor window housing that facilitates rotation of the sensor window housing relative to the housing.

10. The sensor system of claim 9, wherein, as a result of the impact, the sensor window housing moves relative to the bearing.

11. The sensor system of claim 10, wherein:
the bearing comprises a bearing surface;
the bearing surface is retained in contact with a surface of the sensor window housing by a retention force; and
the retention force is overcome by an impact force associated with the impact to cause the sensor window housing to move relative to the bearing.

12. The sensor system of claim 9, further comprising a shear pin coupling the sensor window housing to the bearing,
wherein, as a result of the impact, the shear pin fails, facilitating movement of the sensor window housing relative to the bearing.

13. The sensor system of claim 9, wherein, as a result of the impact, the sensor window housing and the bearing move relative to the housing.

14. The sensor system of claim 11, wherein:
the housing comprises a weakened portion at which the housing deforms as a result of the impact.

15. The sensor system of claim 7, further comprising one or more fins formed on an outer surface of the sensor window housing, wherein the one or more fins are configured to cause a rotation of the sensor window housing about the rotational axis when impinged upon by airflow.

16. A sensor cleaning system for mitigating obstructions to generating sensor data, the sensor cleaning system comprising:
a sensor window housing configured to be mounted relative to a sensor;
a sensor window coupled to the sensor window housing, the sensor window being disposed proximate the sensor such that the sensor senses an environment through the sensor window to generate the sensor data;
an actuator configured to rotate the sensor window relative to the sensor about a rotational axis that extends into a field of view of the sensor; and
a deformable member configured to absorb energy associated with an impact with the sensor window housing or the sensor window that causes movement of the sensor window housing relative to the sensor.

17. The sensor cleaning system of claim 16, wherein:
the sensor window housing comprises a cylindrical outer surface extending between a first end coupled to the sensor window and a second end; and
the deformable member is positioned proximate the second end of the sensor window housing.

18. The sensor cleaning system of claim 16, wherein the deformable member comprises a plurality of shims extending along a length generally parallel to the rotational axis.

19. The sensor cleaning system of claim 16, further comprising:
a housing; and
a bearing having a first surface coupled to the sensor window housing and a second surface coupled to the housing to facilitate rotation of the sensor window housing relative to the housing,
wherein a force associated with the impact overcomes a retention force at the first surface or the second surface and causes the movement of the sensor window housing relative to the sensor frame.

20. The sensor cleaning system of claim 19, further comprising a shear pin providing the retention force.
